(19) United States
(12) Patent Application Publication
(10) Pub. No.: US 2026/0084767 A1
(43) Pub. Date: Mar. 26, 2026

(54) WALKING ROBOT FOR PAINTING AND METHOD OF OPERATING THE SAME

(71) Applicant: Ki Baek KAM, Busan (KR)

(72) Inventor: Ki Baek KAM, Busan (KR)

(21) Appl. No.: 18/959,595

(22) Filed: Nov. 25, 2024

(30) Foreign Application Priority Data
Sep. 25, 2024 (KR) 10-2024-0130127
Oct. 18, 2024 (KR) 10-2024-0143359

(51) Int. Cl. B62D 57/032; B05B 13/04; B25J 11/00; B25J 15/00

(52) U.S. Cl. CPC B62D 57/032; B05B 13/0463; B25J 11/0075; B25J 15/0019

(57) ABSTRACT

Disclosed are a robot configured to walk by using a linear actuator, and a method of controlling the same. An embodiment may provide a walking robot, in which two or more robot legs are connected in a row, the walking robot including a leg including one or more linear actuators, and a controller configured to control the linear actuators, in which the leg includes a plurality of supports disposed in a longitudinal direction of the leg, two or more connection shafts configured to connect the plurality of supports, and the linear actuators connected to at least two connection shafts among the two or more connection shafts.

### CROSS-REFERENCE TO RELATED APPLICATIONS

This application claims the priority of Korean Patent Application No. 10-2024-0143359 filed on Oct. 18, 2024, in the Korean Intellectual Property Office, Korean Provisional Application No. 10-2024-0130127 filed on Sep. 25, 2024, in the Korean Intellectual Property Office, the disclosure of which is incorporated herein by reference.

### BACKGROUND

### Field

The present disclosure relates to a technology related to a walking robot for painting, and more particularly, to a robot configured to walk by using a linear actuator, and a method of controlling the same.

### Description of the Related Art

In the related art, painting robots have been widely applied in various industrial fields such as vehicles, ships, and machines, but there have been several limitations because of space constraints. The painting robot in the related art often has difficulty in moving in complex environments, and the painting robot cannot flexibly operate in a narrow space or a working environment with many obstacles. In particular, there are limitations in allowing the robot to climb or overcome obstacles such as stairs and guardrails, and these limitations degrade working efficiency. As a result, additional infrastructure is required to install and manage the robot.

In addition, because the robot in the related art has difficulty in freely traveling, the robot cannot perform flexible operations, such as rotations in place or diagonal movements, in narrow workspaces or has a limitation in performing the above-mentioned flexible operations. For this reason, the robot has difficulty in smoothly moving in the workspace, and the size and capacity of the robot are inevitably increased to perform particular tasks. This requires a large amount of energy consumption and a large actuator capacity, which causes a problem in that the size and weight of the robot are increased, and the increase in size and weight of the robot makes it difficult to perform management and maintenance.

### SUMMARY

An object to be achieved by the present disclosure is to provide a robot configured to walk by using a linear actuator, and a method of controlling the same.

One aspect provides a walking robot, in which two or more robot legs are connected in a row, the walking robot including: a leg including one or more linear actuators; and a controller configured to control the linear actuators, in which the leg includes: a plurality of supports disposed in a longitudinal direction of the leg; two or more connection shafts configured to connect the plurality of supports; and the linear actuators connected to at least two connection shafts among the two or more connection shafts.

The connection shafts may include: a first connection shaft connected to an upper portion of the leg; a third connection shaft connected to a lower portion of the leg; and a second connection shaft positioned between the first connection shaft and the third connection shaft.

The first connection shaft, the second connection shaft, and the third connection shaft may be rotatably connected to the plurality of supports.

The linear actuators may be rotatably connected to the first connection shaft and the third connection shaft.

The linear actuators may include: first and second linear actuators diagonally connected to the first connection shaft and the third connection shaft, and the first linear actuator and the second linear actuator may be diagonally connected in opposite directions to define an ‘X’ shape.

When one of the first and second linear actuators is extended, the other of the first and second linear actuators may be contracted, such that the leg may move in a traveling direction of the robot.

The first linear actuator and the second linear actuator may be equally extended or contracted to adjust a length of the leg of the robot.

The walking robot may further include: a wheel connected to the third connection shaft.

The wheel may include a wheel driving motor configured to operate the wheel.

The wheel may include a steering motor configured to change a direction of the wheel.

The wheel may further include a slip ring configured to prevent an electric wire from being twisted when the direction of the wheel is changed.

The walking robot may further include: an image sensor configured to create an image, in which the controller controls the linear actuator on the basis of the image.

The walking robot may further include: a spray gun configured to spray a painting material.

According to the embodiment, the robot may freely travel and overcome obstacles even in a narrow space or a complex environment, which may significantly improve the flexibility and efficiency of the task. In addition, with the single actuator structure, it is possible to reduce the size and weight of the robot and the energy consumption, thereby expanding the range of application in various industrial fields.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration view of a walking robot according to an embodiment;

FIG. 2 is an exemplified view for explaining a leg structure of the walking robot according to the embodiment;

FIGS. 3, 4, and 5 are exemplified views for explaining an operation of a walking robot leg; and

FIG. 6 is an exemplified view for explaining the leg structure according to the embodiment walking robot.

### DETAILED DESCRIPTION OF THE EMBODIMENT

Hereinafter, embodiments of the present disclosure will be described in detail with reference to the accompanying drawings. In the description of the present disclosure herein, the specific descriptions of publicly known related functions or configurations will be omitted when it is determined that the specific descriptions may unnecessarily obscure the subject matter of the present disclosure. In addition, the terms used herein are defined considering the functions in the present disclosure and may vary depending on the intention or usual practice of a user or an operator. Therefore, the definition of the disclosure should be made based on the entire contents of the present specification.

Hereinafter, embodiments of a walking robot will be described in detail with reference to the drawings.

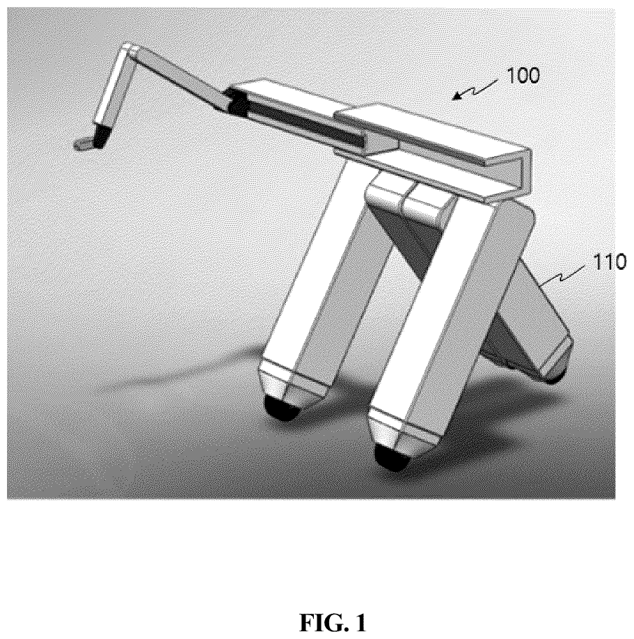

FIG. 1 is a configuration view of a walking robot according to an embodiment.

A walking robot 100 may include two or more robot legs 110. In this case, the two or more robot legs 110 may be connected in a row and include one or more linear actuators. The walking robot 100 may include a controller (not illustrated) configured to control the linear actuators.

According to the embodiment, the leg may include a plurality of supports 115 disposed in a longitudinal direction of the leg, two or more connection shafts configured to connect the plurality of supports 115, and the linear actuators connected to at least two connection shafts among the two or more connection shafts.

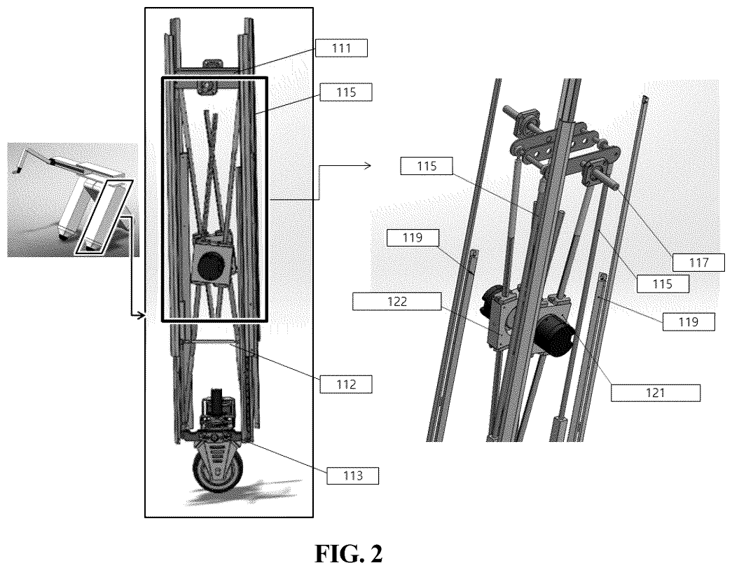

With reference to FIG. 2, the leg may include the plurality of supports 115, and the supports 115 may be disposed in the longitudinal direction of the leg. The two or more connection shafts configured to connect the plurality of supports 115 are provided in the leg structure, and at least two connection shafts, among the connection shafts, may be connected to the linear actuators. In this case, the linear actuators may serve to increase or decrease a length of the leg by adjusting the motion of the connection shaft. Therefore, the leg may be flexibly extended and contracted, and the robot may be moved by the extension and contraction.

According to the embodiment, the connection shafts may include a first connection shaft 111 connected to an upper portion of the leg, a third connection shaft 113 connected to a lower portion of the leg, and a second connection shaft 112 positioned between the first connection shaft 111 and the third connection shaft 113. The first connection shaft 111 and the third connection shaft 113 are the connection shafts respectively positioned on the upper and lower portions of the leg and connected to upper and lower end portions of the leg. The connection shafts may be connected to a main structure of the leg and control a motion of the leg. The second connection shaft may be an intermediate connection shaft positioned between the first connection shaft 111 and the third connection shaft 113 and serve to assist in maintaining distances between the supports 115.

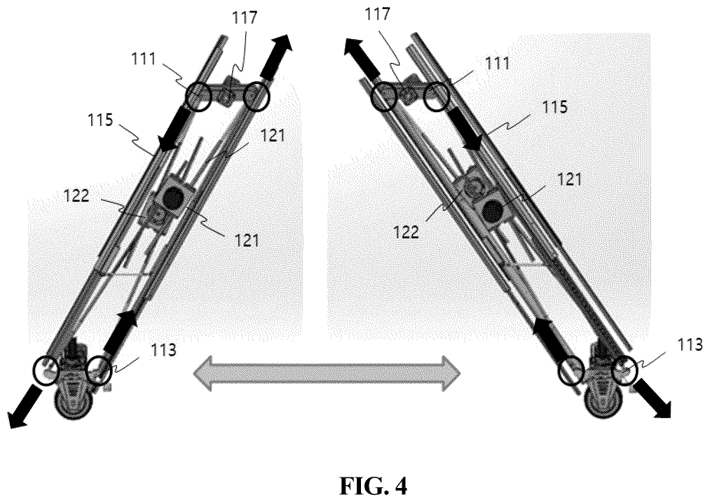

According to the embodiment, the first connection shaft 111, the second connection shaft 112, and the third connection shaft 113 may be rotatably connected to the plurality of supports 115. With reference to FIG. 4, the first connection shaft 111, the second connection shaft 112, and the third connection shaft 113 may be rotatably connected to the plurality of supports 115 and allow the leg to move forward or rearward in a traveling direction. For example, as indicated by the red circles in FIG. 4, the connection shafts may be rotatably connected to the supports 115. Therefore, the robot may move forward or rearward.

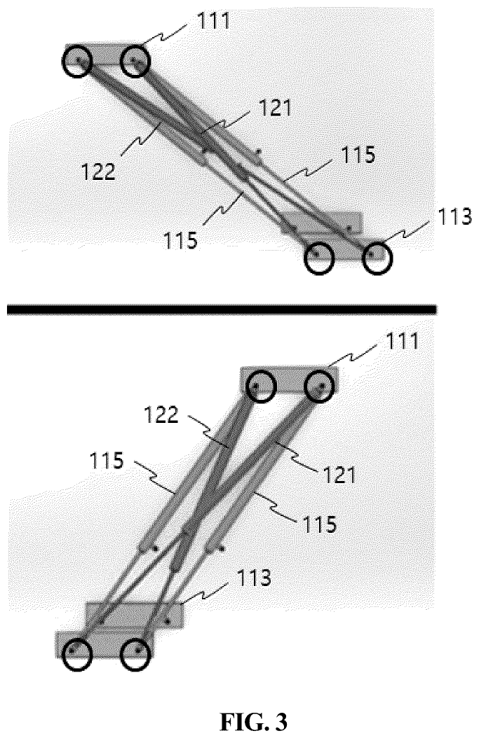

According to the embodiment, the linear actuators may be rotatably connected to the first connection shaft 111 and the third connection shaft 113. With reference to FIG. 3, the first connection shaft 111 and the third connection shaft 113 are respectively connected to the upper and lower portions of the leg. The first connection shaft 111 may support an upper end of the leg, the third connection shaft 113 may support a lower end of the leg, and these two shafts may adjust a length and an angle of the leg by means of the linear actuators. As indicated by the red circles, a first linear actuator 121 and a second linear actuator 122 may be rotatably connected to the connection shafts and adjust the length and the forward and rearward motions of the leg. The leg may flexibly move in a desired direction by means of the operations of the two actuators.

According to the embodiment, the linear actuators may include the first and second linear actuators 121 and 122 diagonally connected to the first connection shaft 111 and the third connection shaft 113, and the first linear actuator 121 and the second linear actuator 122 may be diagonally connected in opposite directions to define an ‘X’ shape. With reference to FIG. 3, the first linear actuator 121 and the second linear actuator 122 may be respectively connected diagonally to the connection shafts and constitute the ‘X’ shape.

According to the embodiment, when one of the first and second linear actuators 121 and 122 is extended, the other of the first and second linear actuators 121 and 122 is contracted, such that the leg moved in the traveling direction of the robot. With reference to FIG. 4, the first linear actuator 121 may be contracted as indicated by the green arrows, and the second linear actuator 122 may be extended as indicated by the red arrows. Thereafter, the first linear actuator 121 may be extended as indicated by the green arrows, and the second linear actuator 122 may be contracted as indicated by the red arrows, such that the leg of the robot may move forward or rearward in the traveling direction.

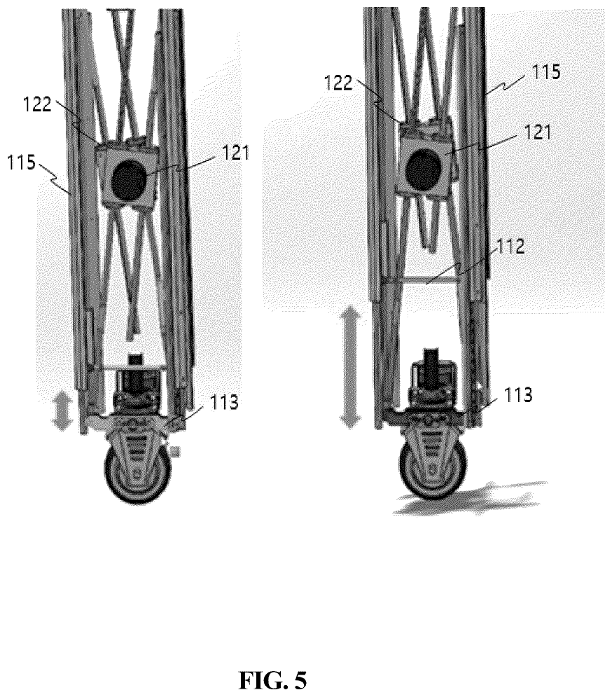

According to the embodiment, the first linear actuator 121 and the second linear actuator 122 may adjust the length of the leg of the robot while being equally extended or contracted. With reference to FIG. 5, the first linear actuator 121 and the second linear actuator 122 may be simultaneously extended or contracted, such that an overall length of the leg may be adjusted.

According to the embodiment, the walking robot may further include a wheel connected to the third connection shaft 113, and the wheel may include a wheel driving motor 133 configured to operate the wheel.

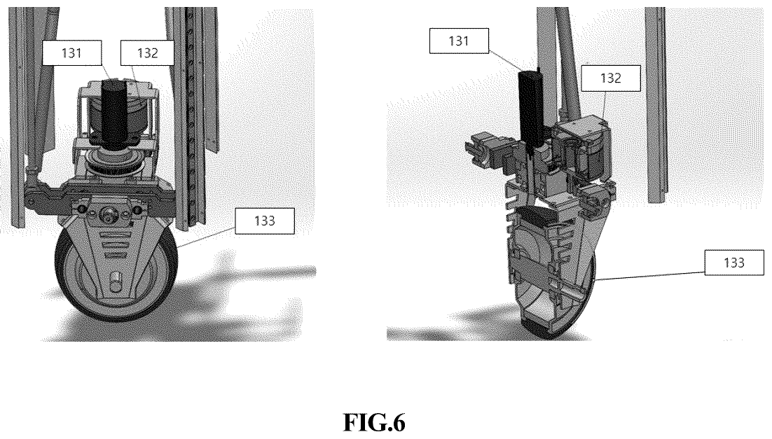

With reference to FIG. 6, the wheel may include the wheel driving motor 133 to operate the wheel and control a rotation of the wheel. The wheel driving motor 133 is provided on a central portion of the wheel and provides power so that the wheel moves the robot while rotating. Because the motor is connected directly to the wheel, such that a speed of the wheel may be precisely controlled, and the wheel may smoothly move on various terrains.

The wheel according to the embodiment may include a steering motor 132 configured to change a direction of the wheel. With reference to FIG. 6, the wheel may include the steering motor 132 to adjust the direction of the wheel. The steering motor 132 may serve to change the direction of the wheel or adjust a rotation angle of the wheel, such that the robot may more flexibly switch the direction. Because the steering motor 132 is connected to the wheel, a traveling route may be precisely controlled, and the direction may be stably changed on a complex terrain or in a narrow space.

According to the embodiment, the wheel may further include a slip ring 131 configured to prevent an electric wire from being twisted when the direction of the wheel is changed. The slip ring 131 refers to a device configured to transmit an electrical signal or electric power between a rotating component and a stationary component. The slip ring 131 is connected to a rotation device such as the steering motor 132 and enables the electric wire to maintain electrical connection without being twisted even while the wheel rotates. Therefore, even in a situation in which the wheel continuously rotates, a signal and electric power may be stably transmitted to electrical devices such as the motor or a sensor.

According to the embodiment, the robot may further include an image sensor configured to create an image, and the controller may control the linear actuator on the basis of the image. The robot may collect, in real time, images of surrounding environments by means of the image sensor and analyze the images. The image sensor may use a device such as a camera to recognize a route, through which the robot moves, and recognize an obstacle existing around the route. The collected image is transmitted to the controller of the robot and used to determine a route for the robot. The controller may calculate a safe route on the basis of the information and control the robot so that the robot may smoothly move to a target point.

The controller of the robot may precisely control the linear actuator on the basis of the image. The controller may control the operations, such as the extension and contraction of the linear actuator, on the basis of the calculated route and obstacle avoidance strategy.

According to the embodiment, the robot may further include a spray gun 150 configured to spray a painting material. Therefore, the robot may perform painting processes in various applications.

The aspect of the present disclosure may be implemented as a computer-readable code on a computer-readable recording medium. Codes and code segments, which constitute the program, may be readily inferred by computer programmers in the art. Examples of the computer-readable recording medium includes all kinds of recording device for storing data readable by a computer system. Examples of computer-readable recording media may include ROM, RAM, CD-ROM, magnetic tapes, floppy discs, optical discs, and the like. In addition, the computer-readable recording media may be distributed to computer systems connected over networks and store and execute computer-readable codes in a distributed manner.

The exemplary embodiments of the present disclosure have been described above. It can be understood that those skilled in the art to which the present disclosure pertains can implement modifications without departing from the intrinsic characteristics of the present disclosure. Accordingly, the scope of the present disclosure is not limited to the above-mentioned embodiment, and various embodiments in the equivalent scope to the disclosure in the claims should be construed as falling within the scope of the present disclosure.

What is claimed is:

1. A walking robot, in which two or more robot legs are connected in a row, the walking robot comprising:
a leg comprising one or more linear actuators; and
a controller configured to control the linear actuators,
wherein the leg comprises:
a plurality of supports disposed in a longitudinal direction of the leg;
two or more connection shafts configured to connect the plurality of supports; and
the linear actuators connected to at least two connection shafts among the two or more connection shafts.

2. The walking robot of claim 1, wherein the connection shafts comprise:
a first connection shaft connected to an upper portion of the leg;
a third connection shaft connected to a lower portion of the leg; and
a second connection shaft positioned between the first connection shaft and the third connection shaft.

3. The walking robot of claim 2, wherein the first connection shaft, the second connection shaft, and the third connection shaft are rotatably connected to the plurality of supports.

4. The walking robot of claim 2, wherein the linear actuators are rotatably connected to the first connection shaft and the third connection shaft.

5. The walking robot of claim 4, wherein the linear actuators comprise:
first and second linear actuators diagonally connected to the first connection shaft and the third connection shaft, and
wherein the first linear actuator and the second linear actuator are diagonally connected in opposite directions to define an ‘X’ shape.

6. The walking robot of claim 5, wherein when one of the first and second linear actuators is extended, the other of the first and second linear actuators is contracted, such that the leg moves in a traveling direction of the robot.

7. The walking robot of claim 5, wherein the first linear actuator and the second linear actuator are equally extended or contracted to adjust a length of the leg of the robot.

8. The walking robot of claim 2, further comprising:
a wheel connected to the third connection shaft.

9. The walking robot of claim 8, wherein the wheel comprises a wheel driving motor configured to operate the wheel.

10. The walking robot of claim 8, wherein the wheel comprises a steering motor configured to change a direction of the wheel.

11. The walking robot of claim 10, wherein the wheel further comprises a slip ring configured to prevent an electric wire from being twisted when the direction of the wheel is changed.

12. The walking robot of claim 1, further comprising:
an image sensor configured to create an image,
wherein the controller controls the linear actuator on the basis of the image.

13. The walking robot of claim 1, further comprising:
a spray gun configured to spray a painting material.
